(19) United States
(12) Patent Application Publication
(10) Pub. No.: US 2006/0278413 A1
(43) Pub. Date: Dec. 14, 2006

(54) Three point hitch for a tractor used for viticulture and/or fruit culture

(76) Inventor: Martin Heitlinger, Ostringe-Odenheim (DE)

Correspondence Address: Deere & Company;Patent Department, One John Deere Place, Moline, IL, 61265-8098, US

(21) Appl. No.: 11/438,174

(22) Filed: May 22, 2006

(30) Foreign Application Priority Data
May 23, 2005 (DE) 10 2005 023 730.4

(51) Int. Cl. A01B 59/06

(52) U.S. Cl. 172/439

(57) ABSTRACT

A three point hitch is provide for a tractor used for viticulture and/or fruit culture. The hitch (10) includes an upper link and two lower links (12, 14). One end of the upper link is pivotally coupled to the tractor at tractor connection point (16) in an upper central area of the three point hitch. An end (18, 64) of each lower link (12, 14) is permanently pivotally connected to the tractor at a pivot point (22) in a lower area of the three point hitch. The pivot points (22) of lower links (12, 14) are positioned adjacent to each other.

### BACKGROUND

The invention pertains to a three point hitch for a tractor used for viticulture and/or fruit culture.

A three point hitch includes an upper central link and two lower links. The upper central link and the lower links are permanently pivotally connected to tractor connection points.

Such three point hitches have long been known in prior art. For example, DIN ISO Standard 730 1 describes the dimensions and requirements for a three point hitch for linking implements or equipment to the rear of agricultural tractors.

In viticulture and fruit culture, and in similar types of agriculture, special demands that differ from those in the normal field of application of agricultural tractors are placed on a three point hitch. Tractors used in these types of agriculture generally drive through relatively narrow rows and therefore have a narrow track (e.g., 960 mm). Work is often carried out on steep, inclined terraces. This requires a three point hitch with which an implement coupled to a tractor can be oriented three dimensionally within certain limits. Its position is preferably adjusted by the operator from the tractor seat with the assistance of the hydraulic system of the tractor.

In particular, when driving through a vineyard row, the implement must be moved deliberately towards or away from the row, and in two fundamentally different ways. In one case, with the aid of the three point hitch, the implement is pivoted laterally about a substantially vertical pivot axis towards or away from a row. This is called “lateral sway” or “row guiding” in English. In the other case, the implement is tilted or pivoted with the aid of the three point hitch about a substantially horizontal pivot axis. This is called “vertical sloping” or “row side to row side”.

A specially constructed three point hitch, with which the two just described implement motions relative to the tractor can be performed, is shown in prior art patent reference EP 0 259 801 A1. In this three point hitch, the lower links provided are rigidly connected to each other and form, in essence, a U-shape. A simultaneous tilting of the lower links for raising or lowering is possible with two lifting cylinders. Performance of a lateral sway movement of the lower links is possible with two short stroke cylinders specially provided and arranged for this purpose. Performance of a vertical sloping movement of the lower links is possible with two additional short stroke cylinders specially provided and arranged for this purpose.

This three point hitch represents an elaborate and therefore expensive design. Severe demands are placed on the individual components, particularly on the short stroke cylinders. This results in a high degree of wear and tear on the components.

### SUMMARY

Accordingly, an object of this invention is to provide a three point hitch of the type mentioned above, by which the above mentioned problems can be overcome.

A further object of the invention is to provide such a hitch which has a simple and more economical and construction, with nearly the same functions.

These and other objects are achieved by the present invention, wherein a three point hitch of the type mentioned above, wherein the lower links are connected to the tractor at pivot points which are located spatially close together.

This hitch includes components similar to the components of a conventional three point hitch conforming to DIN ISO 730 1. Thus, the lower links can be arranged so as to be adjustable in orientation relative to one another. It is therefore not absolutely required that the lower links have a U shape and be rigidly connected to one another, as in EP 0 259 801 A1. Because the lower links have pivot points which are close together, the lower links and an implement may be moved about a vertical pivot axis, in order to turn the implement towards or away from a row. The vertically pivot axis is defined by the position pivot points of the lower links. In the simplest case, a lower link could then have a substantially straight line shape, and the lower links would then extend towards implement coupling points in substantially a V shape diverging from the pivot points. In that sense, components nearly identical to those of a conventional three point hitch could be used, so that a three point hitch especially adapted for fruit culture and viticulture could be provided economically and commercially in a particularly advantageous manner.

In the known three point hitch shown in EP 0 259 801 A1, the vertical pivot axis is situated further forward on the tractor, near the high wheel axle of the tractor, so that a pivot angle of roughly 4 to 5 degrees with respect to the high wheel axle is possible. With a conventional three point hitch conforming to DIN ISO Standard 730 1, i.e., with widely spaced lower link pivot points, a pivot angle of only about 2 degrees is possible. Because the lower link pivot points of the invention are close together, a pivot angle of about 4 degrees can be achieved.

The lower link pivot points may be directly adjacent each other. Consequently, there is no housing or no frame part on the tractor between the two pivot points. The articulated connections of the lower link could directly contact each other. Accordingly, the pivot points would not be more than about 10 cm apart, depending on the thickness of lower links. The two pivot points act substantially like a single shared pivot point. The actual arrangement of the lower link pivot points depends in on the specific configuration or design of the tractor or towing vehicle. Therefore, the distance between the lower link pivot points is preferably not be greater than 20% of the wheelbase of the tractor. The distance between the lower link pivot points is preferably approximately 10% of the tractor's wheelbase.

Preferably, the distance between the lower link pivot points is selected such that the horizontal convergence distance has a predetermined value at which, on the one hand, lateral pivoting of an implement coupled to the tractor is possible, and on the other, a predetermined lateral guiding of the implement exists. The horizontal convergence distance has great significance for the horizontal stability of the implement coupled to the tractor and runs from the implement side coupling points of the implement to a convergence point. The convergence point is defined by the intersection of the longitudinal axes of the lower links, or as the extension of the connecting paths between the implement side coupling points of the lower links and the lower link pivot points. If the convergence distance is too large, the lateral stability of direction independent implements is reduced so that, for instance, plows produce an uneven and crooked furrow. If the horizontal convergence distance is too small, direction independent implements—harrows, for instance—easily find stable positions, possibly asymmetrically to the tractor. For many implements, particularly long multi-row ones, this results in poorer quality of work. If the tractor side pivot points are arranged directly alongside one another, the convergence point, about which an implement coupled to the tractor can pivot laterally in the horizontal direction, is arranged essentially at the location of the tractor side pivot points. If the two tractor side pivot points are arranged somewhat further apart, the convergence point is thereby shifted further forward along the tractor's longitudinal axis, and thus the horizontal distance is increased, compared to the directly adjacent arrangement of the tractor side pivot points.

The lower link pivot points could be located near the tractor's longitudinal plane and/or on a frame or a housing part of the tractor at a lower area. In this regard, the tractor's longitudinal plane is understood to mean the plane that is defined by the tractor's longitudinal axis and a plumb line. Accordingly, the pivot points are located between the tractor wheels, such as centered between the rear wheels. The pivot points could be situated on the tractor differential housing. The tractor side pivot points are preferably arranged close to the tractor's longitudinal axis, in particular, close to the rear axle. The tractor side pivot points can be located to optimize transmission of force from the implement into the tractor.

The lower links are positioned by an actuator. An actuator could be assigned to each lower link. Such an actuator could be a length adjustable strut which pivots or turns the lower link about a substantially horizontal axis, defined by the tractor side pivot point, is possible.

Preferably, a lifting strut is pivotally coupled to each lower link about a pivot axis which is transverse to the longitudinal axis of the lower link. The articulated joint could also permit an additional rotational movement of the lower link's longitudinal axis relative to the lifting strut. Specifically, the articulated joint could be formed by a fork end of the lifting strut which extends around both sides of the lower link, and a bolt which extends through a bore.

Preferably, a lifting arm with a pivot point for a lifting strut is provided on the tractor side. A lifting strut is articulated at one end to a pivot point on the lifting arm, and at its other to a pivot point for the lifting strut of a lower link. The lifting arm can be moved with an actuator, such as a hydraulic cylinder. Preferably, two laterally arranged lifting arms that are rigidly connected to a shaft rotatably seated on the tractor could be provided. With the assistance of two likewise laterally arranged actuators, the lifting arms could be rotated or pivoted about the shaft, whereby the spatial orientation of lower links could be changed uniformly.

In a particularly preferred embodiment, the pivot point of a lower link that is provided for a lifting strut is arranged substantially at that point of a lower link where the connecting line between the tractor side pivot point of the lower link and the coupling point of the lower link for an implement runs. This arrangement of the pivot point for the lifting strut on the lower link has the effect that the weight of the implement that is to be absorbed by the three point hitch is directed into a lifting strut without torque, so that over time the lifting strut is advantageously not subjected to wear and tear or deformation of the type that was observed in practice with conventional three point hitches. Depending on the specific embodiment of the lower link, this does not avoid the introduction of torque into the lower link itself. It does not, however, cause such types of wear phenomena, assuming there is a suitably stable design of the lower ink itself as well as an appropriately dimensioned tractor side pivot point for the lower link.

It is particularly preferred that at least one lifting strut be designed to be longitudinally displaceable. Such a lifting strut is preferably displaced longitudinally with a motor or hydraulically. Accordingly, a lifting strut comprises an actuator function. For this purpose, it could be possible, for instance, to provide a hydraulic cylinder that is driven with a single or double action. Thus one lifting strut with a longitudinally displaceable configuration can actuate the lower link with which it is associated, separately from the other lower link.

In principle, there are several possible alternatives for how the lifting strut can be constructed specifically to interact with the lower links. Thus, for instance, a double acting actuator that could be embodied in the form of a hydraulic cylinder could be provided as a lifting strut for a lower link. For the other lower link, a lifting strut constructed to be rigid or manually adjustable, but not adjustable in length while in operation, could be provided. With this alternative, both lower links could be jointly pivoted upward or downward with the assistance of the two lifting arms, the lifting shaft and the lifting cylinder. With the double acting actuator as lifting strut, the lower link associated with this lifting strut could be pivoted upward or downward independently of the other lower link, so that the endpoints of the lower links on the implement side could assume different vertical positions, whereby a “vertical sloping” movement of the implement is possible.

In an alternative, a single acting actuator, which can likewise be constructed in the form of a hydraulic cylinder, is provided as the lifting strut for each lower link. The actuator operates such that it actively shortens the lifting strut, whereby the associated lower link is moved. A lowering of the lower link, which is achieved on its own due to the weight of the implement, can be achieved by deactivation of the actuator or releasing the hydraulic cylinder pressure. In this way, the spatial orientation of the lower links can be varied independently of one another by their respectively provided actuator or lifting strut. In this case, the lower links can be adjusted to a greater difference of vertical height, whereby it is possible to increase the pivot angle of an implement about a substantially horizontal axis for carrying out a “vertical sloping” movement. By jointly shortening both actuators, the lower link can also be brought into an even higher position, which is desirable for certain implements or applications.

It is also conceivable for a double acting actuator to be provided as a lifting strut for each lower link, in the form of hydraulic cylinders. With these, one could achieve an effect comparable to the alternative just discussed.

In a particularly preferred embodiment, at least one stabilizer element that is longitudinally displaceable (preferably by motor or hydraulic power) is provided. The stabilizer element can be arranged at one end on a tractor side pivot point, and at the other end on a pivot point on a lower link. The pivot points of the stabilizer element likewise have at least one degree of freedom, preferably two. With the stabilizer element or elements, the implement can be pivoted about a substantially vertically arranged pivot axis towards or away from a row, that is to say, a “lateral sway” movement can be brought about.

A stabilizer element could be associated with only one lower link. The stabilizer element may be a double acting actuator or hydraulic cylinder, which can move the lower link in two opposite directions. Alternatively and preferably, one stabilizer element is associated with each lower link. The two stabilizer elements are expediently arranged such that an implement coupled to the three point hitch can be pivoted to the right with one stabilizer element and to the left with the other.

A tractor side pivot point of a lower link and/or an upper link comprises an articulated joint with at least two degrees of freedom with which, for instance, a tilting motion of the lower link or upper link about a tilt axis arranged substantially horizontally and a pivoting motion of the lower link or upper link about a pivot axis arranged substantially vertically can be performed. The articulated joints could be known conventional articulated joints.

If the three point hitch is arranged on the rear end of the tractor, the lower link pivot points could be arranged further forward with respect to the tractor's longitudinal axis than the tractor side pivot point of the upper link. In this way, the maximum achievable “lateral sway” movement can be increased even further.

A tractor used for viticulture or fruit culture must have a narrow track, roughly 1 meter, for example. Since the three point hitch of the invention is normally mounted on the rear end of the tractor, and the housing for the axle differential, as well as the wheels with a relatively narrow track, is arranged there, it will be necessary as a rule to construct the lower link of the hitch of the invention such that it is adapted to the prevailing spatial conditions. For this purpose, the lower link preferably comprises in its end facing the tractor, a first section with a first longitudinal axis that is oriented substantially parallel to the tractor's longitudinal axis in the state when it is mounted on the tractor. A second section of the lower link with a second longitudinal axis adjoins the first section of the lower link. The first longitudinal axis and the second longitudinal axis are arranged relative to one another at an angle, preferably in a manner such that the second sections of the lower links diverge when the lower link is mounted on the tractor. The second section is therefore preferably constructed in a straight line, but could comprise a bend or a curved shape.

Adjoining the second section of the lower link is a third section with a third longitudinal axis, which is oriented substantially parallel to the tractor's longitudinal axis when the lower link is mounted on the tractor. An additional section of the lower link with an additional longitudinal axis adjoins the second or third section of the lower link. The additional section of the lower link is constructed such that when the lower link is mounted on the tractor, the additional longitudinal axis is oriented substantially perpendicular to the tractor's longitudinal axis, and preferably substantially horizontally. Thus a lower link is shaped such that it extends to the rear and to the side from the tractor side pivot point arranged in the vicinity of the tractor's longitudinal axis, so that implement side interface means, such as lower link catch hooks, are arranged behind the rear wheels.

As already suggested, implement side interface means are provided that are constructed so that they can be adapted to various categories of implements. For this purpose, a lower link could comprise an elongated hole in its fourth or additional region—the side of the lower link facing the implement—so that an interface means that is attached to the additional region can be displaced or positioned in at least one direction. Lower links of differing form could be provided, with which links the three point hitch of the invention could be adapted for the use With different tractor wheels.

### BRIEF DESCRIPTION OF THE DRAWINGS

FIG. 1 is a rear view of part of the rear end of a tractor having an embodiment of a the hitch of the invention;

FIG. 2 is a view from below of the embodiment of FIG. 1;

FIG. 3 is a plan view of an embodiment of a lower link for a the hitch of the invention; and

FIG. 4 is a side view of the lower link of FIG. 3.

### DETAILED DESCRIPTION

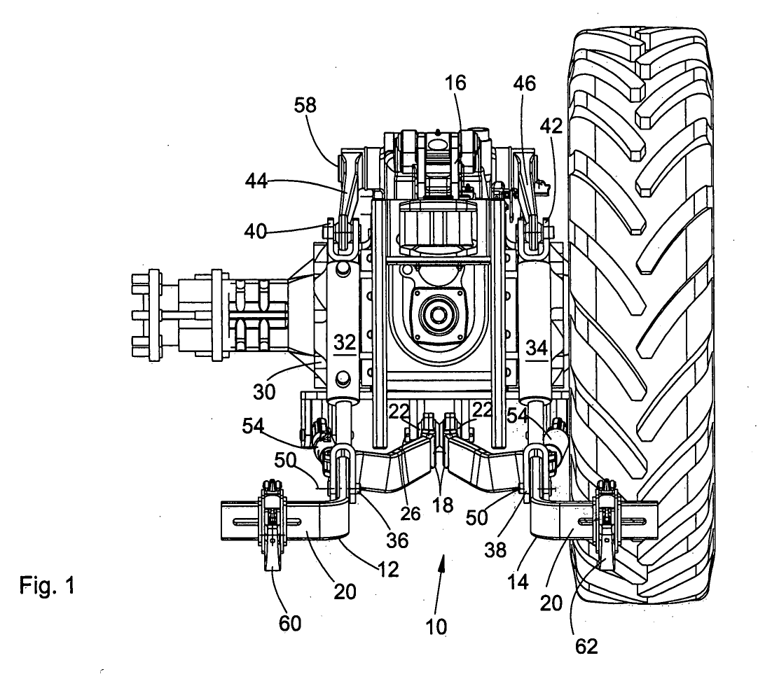

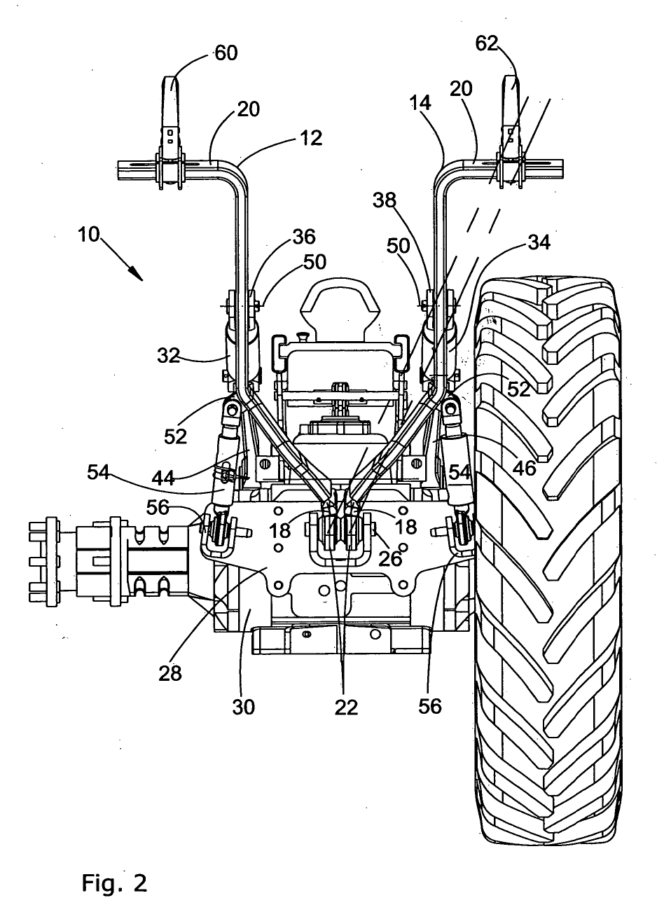

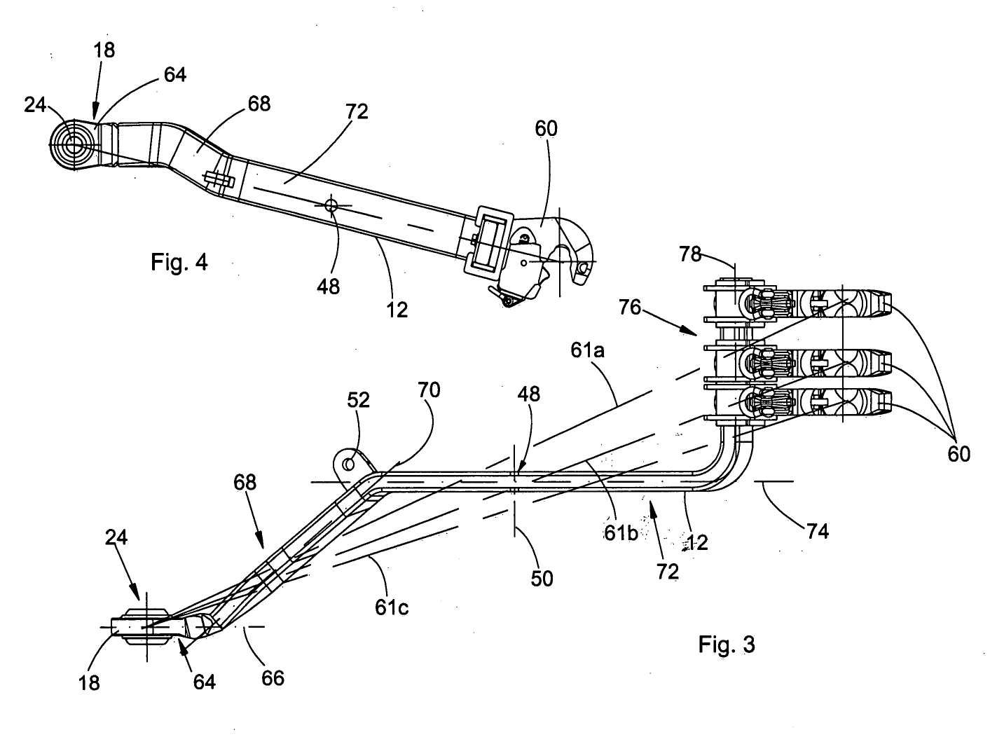

Referring to FIGS. 1 and 2, a three point hitch 10 comprises two lower links 12, 14 and an upper link (not shown). The upper link is articulated to the tractor at a tractor side pivot point 16 which is located at a central and upper area at the rear end of the tractor. Lower link 12 is shown in detail in FIGS. 3 and 4. Only the differential housing of the tractor, as well as part of the axle with the right wheel, is shown in FIGS. 1 and 2.

Lower link 12 has an end 18 facing the tractor and an end 20 facing away from the tractor. Accordingly, the lower links 12, 14 are articulated to the tractor, at the tractor side pivot points 22, with their ends 18 facing the tractor. The pivot points 22 are arranged directly next to one another. Specifically, lower links 12, 14 have bores 24 through which bolt 26 extends, so that both lower links 12, 14 are coupled to the tractor by the same bolt 26. Bolt 26 is preferably a sensor bolt which can detect the tensile force transferred to lower links 12, 14 by an implement coupled to three point hitch 10. Tractor side pivot points 16, 22 of the upper link, not shown, and lower links 12, 14 permit a tilting motion of the upper link or lower links 12, 14, about a horizontal axis that is defined for both pivot points 22 by the longitudinal axis of bolt 26. To a certain degree, both upper link and lower links 12, 14 can effect a pivoting motion about a substantially vertically axis, which in the case of lower links 12, 14 is disposed on pivot points 22 or on bolt 26.

As best seen in FIG. 2, pivot points 22 are mounted on a subassembly 28, which can be bolted to the underside of differential housing 30. Because subassembly 28 can be bolted to differential housing 30, it is possible in a particularly advantageous manner to retrofit tractors with a conventional three point hitch in order to then use the functionality of the invented three point hitch 10 for viticulture and fruit culture in particular.

For each lower link 12, 14, a respective actuator 32, 34 is provided in the form of a double acting hydraulic cylinder which functions as a lifting strut. Actuator 32 or 34 is articulated at one end 36 or 38, respectively, to lower link 12 or 14, respectively, and at its other end 40 or 42, respectively, to lifting arm 44 or 46, respectively. Ends 36, 38 and 40, 42 of actuators 32, 34 are constructed with fork shapes and are connected by bolts (not shown) to lower links 12, 14 and lifting arms 44, 46, respectively.

Pivot point 48 of lower link 12 for end 36 of actuator 32 is shown in FIGS. 3 and 4. Pivot point 48 comprises a bore through which a bolt extends. Coupled end 36 of actuator 32 at pivot point 48 of lower link 12 thus constitutes an articulated connection with which actuator 32 can perform a rotational or pivoting motion relative to lower link 12 about axis 50. Moreover, fork shaped end 36 is dimensioned such that a relative motion between lower link 12 and actuator 32 is possible, to a certain degree, about an axis that is defined substantially by longitudinal axis 12 in the area of pivot point 48.

On each lower link 12, 14, a pivot point 52 is provided to which a fork shaped end of a stabilizer element 54 is linked. At its other end, stabilizer element 54 is linked to a respective tractor side pivot point 56, tractor side pivot points 56 being provided by subassembly 28, as best seen in FIG. 2. The two ends of stabilizer element are each articulated with a bolt at corresponding pivot points 52, 56 to lower link 12, 14 or subassembly 28, respectively. Stabilizer elements 54 are each constructed in the form of a single acting hydraulic cylinder, as shown at the right in FIG. 2. Alternatively, stabilizer elements 54 can also each be manually length-adjustable, as shown at the left in FIG. 2. The differently represented stabilizer elements 54 in FIG. 2 serve to illustrate that two differently-constructed types of stabilizer elements 54 can be employed.

The mode of operation of the invented three point hitch 10 according to FIGS. 1 and 2 will be described below. In the state of the three point hitch 10 shown in FIG. 1, the lower links 12, 14 are in a lower position. If both lower links 12, 14 are to be raised identically, this is done by actuating lifting arms 44, 46, which are fixed to lifting shaft 58 in rigid or torque-proof fashion. Lifting shaft 58 is operated by lifting cylinders (not shown in FIGS. 1 and 2) that are arranged inside the housing. If lifting arms 44, 46 are then rotated upwards about the axis of rotation defined by the longitudinal axis of lifting shaft 58, then the lower links 12, 14 are likewise raised upwards by way of actuators 32, 34, actuators 32, 34 remaining in an unchanged length position in the process. A lowering of lower links 12, 14 is analogously performed in the opposite direction. It is also conceivable to raise the lower links 12, 14 maximally by moving lifting arms 44, 46 into their uppermost position and then additionally extending or retracting actuators 32, 34 maximally.

It is additionally possible to lower one lower link (e.g., 12) individually and to lift the other lower link (e.g., 14) individually. For this purpose, actuator 32 would have to be extended and actuator 34 retracted. In that way, an implement coupled to the tractor can be turned or pivoted about a substantially horizontal axis oriented parallel to the tractor's longitudinal axis. Thus, a “vertical sloping” motion of the implement can be achieved. If right stabilizer element 54 is varied in length, the lateral position of lower link 14 is thereby varied, whereby the end 20 of lower link 14 that faces away from the tractor is moved away from or brought closer to the tractor's longitudinal axis. Lower link 12 is thereby correspondingly moved, since its end 20 facing away from the tractor is also connected to an implement (not shown) so that the distance between ends 20 of lower links 12, 14 remains unchanged. Accordingly, a “lateral sway” movement can be performed by actuating stabilizer element or elements 54, and an implement coupled to the tractor can thereby moved closer to or away from a fruit plant row to the left or right of the tractor. The “lateral sway” movement of the implement is performed about a substantially vertical pivot axis arranged in the vicinity of tractor side pivot points 22.

For coupling an implement to lower links 12, 14, catch hooks 60, 62, which can be fixed in various transverse positions on lower link 12 or 14, are provided. Three catch hooks 60 are shown in FIG. 3 to express the fact that catch hooks 60 can be fixed in different positions. These positions indicate a degree of spreading that corresponds to an implement of class 1, 2 or less than 1. The effect of the different positions of catch hook 60 on pivot point 48 of lower link 12 is indicated with connecting lines 61a 61c. With respect to the middle position of catch hook 60, pivot point 48 is exactly at the intersection of longitudinal axis 74 of lower link 12 and connecting line 61b. For the other two positions of catch hook 60, there is no intersection at the level of pivot point 48, or in the direction of axis 50, between connecting lines 61a, 61c and longitudinal axis 74 of this section of lower link 12. However, the intersections of lines 61a, 61c and axis 50 are not far from lower link 12. To that extent, a torque is introduced into the lifting struts if catch hooks 60 are in the two outer positions shown in FIG. 3. This torque, however, is small compared to the torque that is introduced into the lifting struts in conventional three point hitches, since the distance in that case between the corresponding connecting lines of tractor side and implement side pivot points, in a direction comparable to axis 50 of FIG. 3, is much larger.

Referring now to FIG. 3, lower link 12 has a first section 64 with a first longitudinal axis 66 at its end 18 facing the tractor. When linked to the tractor, first section 64 or longitudinal axis 66 is oriented substantially parallel to the longitudinal plane of the tractor. First section 64 of lower link 12 is adjoined by a second section 68 of lower link 12 with a second longitudinal axis 70. First longitudinal axis 66 and second longitudinal axis 70 are arranged at an angle to one another such that when lower links 12, 14, are linked to the tractor, second sections 68 of lower links 12, 14 diverge with respect to tractor side pivot point 22, as is clearly discernible from FIG. 2.

Second section 68 of lower link 12 is adjoined by a third section 72 of lower link 12 with a third longitudinal axis 74. When the lower link is linked to the tractor, third section 72 is substantially parallel to the longitudinal plane of the tractor. It can be seen from FIG. 2 that the two third sections 72 of lower links 12, 14 are substantially parallel to one another.

Third section 72 of lower link 12 is adjoined by a fourth section 76 of the lower link with a fourth longitudinal axis 78. Fourth section 76 of lower link 12 is constructed such that when lower link 12 is linked to the tractor, additional longitudinal axis 78 is oriented substantially horizontally and perpendicular to the tractor's longitudinal axis. Catch hook 60, which can be fixed at various positions along the longitudinal axis 78, as shown in FIG. 3 with three different positions, is fastened to section 76.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

1. In a three point hitch for a tractor used for viticulture and/or fruit culture, the hitch having an upper link and a pair of lower links, the upper link being pivotally coupled to the tractor at an upper central area of hitch, each lower link having a tractor end pivotally coupled to the tractor by a pivot point at a lower area of the hitch, characterized in that:
the pivot points are adjacent to each other.

2. The hitch of claim 1, wherein:
the distance between pivot points is not greater than approximately 10% of a wheelbase of the tractor.

3. The hitch of claim 1, wherein:
the distance between the pivot points is selected so that the lower links have a certain horizontal convergence distance which enables a lateral pivoting of an implement linked thereto, and which enables a predetermined lateral guiding of the implement.

4. The hitch of claim 1, wherein:
the pivot points are adjacent to a longitudinal plane of the tractor, and close to a rear axle of the tractor.

5. The hitch of claim 1, further comprising:
a pair of actuators, each actuator being is coupled to a corresponding one of the lower links, so that a position of each lower link can be changed independently.

6. The hitch of claim 1, wherein:
each lower link has a lift strut pivot point for pivotally coupling to a lifting strut, each lift strut pivot point enabling a rotational movement of the lower link relative to the lifting strut about an axis of rotation transverse to a longitudinal axis of the lower link, and also enabling an additional rotational movement of the longitudinal axis of lower link relative to lifting strut.

7. The hitch of claim 6, further comprising:
a pair of lifting arm, each pivotally coupled to one of the lifting struts and to the tractor, each lifting strut is having a first end pivotally coupled to one of the lifting arms and having a second end pivotally coupled to one of the lower links, and an actuator for moving each lifting arm.

8. The hitch of claim 6, characterized in that:
for each lower link, a connecting line extends between the pivot point and an implement coupling end of the lower link, and each lifting strut is pivotally coupled to one of the lower links at a point adjacent to said connecting line.

9. The hitch of claim 6, wherein:
the lifting strut comprises a length adjustable hydraulic cylinder.

10. The hitch of claims 6, wherein:
the lifting strut comprises a double acting actuator.

11. The hitch of claims 6, wherein:
a single acting hydraulic cylinder is provided for each lower link.

12. The hitch of claim 6, wherein:
each lifting strut comprises a double acting hydraulic cylinder for each lower link.

13. The hitch of claim 1, further comprising:
a longitudinally adjustable stabilizer element, one end of the stabilizer element being pivotally coupled to the tractor, and another end of the stabilizer element being pivotally coupled to one the lower links.

14. The hitch of claim 1, characterized in that:
a pair of stabilizer elements, each coupled to one of the lower links, each stabilizer element comprising a double acting hydraulic cylinder for moving the lower link in two opposite directions.

15. The hitch of claim 1, wherein:
each pivot point comprises an articulated joint with at least two degrees of freedom so that the lower links can be tilted about a horizontal axis and pivoted about a vertical axis.

16. The hitch of claim 1, wherein:
the hitch is arranged on a rear end of the tractor; and
the pivot points are arranged forward of a tractor side pivot point of the upper link.

17. The hitch of claim 1, wherein:
each lower link comprises a first section adjacent to the tractor, the first section having a first longitudinal axis which is oriented substantially parallel to a longitudinal axis of the tractor.

18. The hitch of claim 17, wherein:
each lower link comprises a second section adjoining first section, the second section having a second longitudinal axis at an angle with respect to the first longitudinal axis so that the second sections diverge away from each other.

19. The hitch of claim 18, wherein:
each lower link comprises a third section adjoining the second section, the third section having a third longitudinal axis which is oriented substantially parallel to the tractor longitudinal axis.

20. The hitch of claim 19, wherein:
each lower link comprises a fourth section adjoining the third section, each fourth section having a fourth longitudinal axis which is oriented substantially horizontally and perpendicular to the tractor longitudinal axis.

21. The hitch of claim 1, further comprising:
an adaptable interface for coupling to various categories of implements.

22. The hitch of claim 1, wherein:
the pivot points are mounted on a subassembly, and the tractor is designed for use in viticulture and/or fruit culture.

23. The hitch of claim 1, wherein:
the distance between the pivot points is not greater than 20% of a wheelbase of the tractor.

24. The hitch of claim 1, wherein:
each lower link comprising a first section adjacent to the tractor, the first section having a first longitudinal axis which, when mounted at the tractor, is oriented substantially parallel to a longitudinal axis of the tractor, a second section adjoining first section, the second section having a second longitudinal axis at an angle with respect to the first longitudinal axis so that the second sections diverge away from each other, and a third section adjoining the second section, the third section having a third longitudinal axis which is oriented substantially parallel to the tractor longitudinal axis.

25. The hitch of claim 24, wherein:
each lower link further comprising a fourth section adjoining the third section, the fourth section having a fourth longitudinal axis which is oriented substantially horizontally and perpendicular to the tractor longitudinal axis.

26. The hitch of claim 24, wherein:
each lower link having a tractor end pivotally coupled to the tractor by a pivot point and an implement coupling end, wherein a connecting line extends between the pivot point and the implement coupling end of the lower link; and
a lifting strut is pivotally coupled to the lower link at a point adjacent to said connecting line.

27. A hitch-toolkit comprising:
a subassembly mountable to a tractor, the subassembly providing tractor side connecting points for draft links of a three point hitch, the three point hitch having an upper link and a pair of lower links, each lower link having a tractor end, the tractor ends being pivotally coupled to the subassembly at pivot points which are directly adjacent to each other.

28. The hitch-toolkit of claim 27, wherein:
the subassembly includes the pair of lower links.
